(19) United States
(12) Patent Application Publication
(10) Pub. No.: US 2011/0321122 A1
(43) Pub. Date: Dec. 29, 2011

(54) SPECIFYING AN ACCESS CONTROL POLICY

(75) Inventors: Eva Wanjiru Mwangi, Eindhoven (NL); Milan Petkovic, Eindhoven (NL)

(73) Assignee: KONINKLIJKE PHILIPS ELECTRONICS N.V., EINDHOVEN (NL)

(21) Appl. No.: 13/254,203

(22) PCT Filed: Feb. 26, 2010
(86) PCT No.: PCT/IB10/50850

§ 371 Date: Sep. 1, 2011

(30) Foreign Application Priority Data
Mar. 4, 2009 (EP) 09154289.4

(51) Int. Cl. G06F 21/00

(52) U.S. Cl. 726/1

(57) ABSTRACT

A system for specifying an access control policy comprises: A user interface (13) for enabling a user to specify a plurality of policy rules comprising a subject attribute, an object, an action, and an authorization, the policy rules defining an access control policy (10). A translation means (9) for translating the access control policy into a machine readable data access control policy language to obtain a translated data access control policy (14). An output (11) for providing the translated data access control policy to an access control policy enforcing unit (50). A conflict detection means (2) for detecting at least two conflicting policy rules indicative of denial and allowance, respectively, of a possible access request. A conflict indication means (6) for indicating to a user information relating to the conflict. A conflict resolution input (7) for retrieving information from a user indicative of a conflict resolution.

### FIELD OF THE INVENTION

The invention relates to specifying an access control policy, in particular specifying an access control policy for access to medical patient data.

### BACKGROUND OF THE INVENTION

In the past, healthcare institutions used paper based systems to handle patient medical information. Modern consumer healthcare architectures tend to be open, interconnected and flexible. In the professional medical domain this resulted in the adoption of Electronic Health Record (EHR) systems. The aim of EHR systems is to improve the quality of care by making medical information readily available; increasing the efficiency of delivery of services in the healthcare setting, by the electronic exchange of health information; safer patient care due to increased availability and quality of health information; and saving costs associated with manual systems.

EHR systems are already in widespread use in healthcare institutions worldwide, which implies that personal health information can be accessible from numerous sources, therefore increasing the scale of risk of a security breach. These reasons lead to increased concern regarding invasion of privacy and confidentiality which resulted in incorporation of patient consent mechanisms into EHR systems. Consent has its origins in the Hippocratic Oath, taken by healthcare providers to swear confidentiality to their patients. The dictionary definition of consent is permission or agreement. Consent is also defined as the agreement, express or implied, to an action based on knowledge of what the action involves, its likely consequences and the option of saying no. A patient's medical data may only be revealed with the patient's explicit or implied consent; wherein explicit consent is expressed by the patient orally or in writing, and wherein implicit consent is inferred from a person's conduct. The consent preferably includes authorizations which specify who is able to access patient records and for what purpose.

To protect the privacy of patients, EHR systems may be access controlled, and these access control mechanisms may take into consideration the individual's consent when resolving access requests. Currently, individual explicit consent is obtained in written form in standard documents which the patient is asked to sign, and which documents describe the rights and obligations of the patient and the healthcare institution, in particular in respect of privacy concerns (e.g. IHE Basic Patient Privacy Consents).

The privacy policy applied in an EHR system for a particular patient may be expressed in form of a XACML policy, for example. XACML stands for OASIS eXtensible Access Control Markup Language. It is, however, difficult to specify XACML policies correctly. A method for analyzing an access control policy using free variable tableaux has been disclosed in “Access control policy analysis using free variable tableaux”, in IPSJ Digital Courier, Vol. 2, May 2006, pages 207-221, by Hiroaki Kamoda et al.

### SUMMARY OF THE INVENTION

It would be advantageous to have an improved system for specifying an access control policy. To better address this concern, in a first aspect of the invention a system is presented that comprises

a user interface for enabling a user to specify a plurality of policy rules comprising a subject attribute, an object, an action, and an authorization, the policy rules defining an access control policy;

a translation means for translating the access control policy into a machine readable data access control policy language to obtain a translated data access control policy; and

an output for providing the translated data access control policy to an access control policy enforcing unit.

This allows the user to specify the policy rules via a user interface in a user friendly way. It is not necessary to have knowledge of a data access control policy language. Instead, the policy rules can be specified via the user interface, after which they are translated into the data access control policy language automatically, and provided to the enforcing unit for execution. Because the translation is performed automatically, fewer errors occur in the creation of the translation.

A conflict detection means may be provided for detecting at least two conflicting policy rules indicative of denial and allowance, respectively, of a possible access request. This helps to create error-free policies, because conflicts are detected in the policy specification stage, before the rules are first applied to actual access requests. The conflict detection means may be arranged for being activated upon entering of a new policy rule by the user, which enables the user to obtain immediate feedback while specifying the policy.

The conflict detection means may be arranged for detecting conflicting policy rules which are indicative of denial and allowance, respectively, of a particular type of access to a particular object by a particular subject. The authorization of an access request by this particular subject to perform the particular type of access to the particular object cannot be resolved, because one policy rule would permit it whereas another policy rule would deny it. Consequently this is an effective way to detect conflicting policy rules.

The system may further comprise a conflict resolution means for resolving the conflict in the at least two conflicting policy rules to obtain a corrected access control policy, the conflict resolution means comprising a conflict indication means for indicating to a user information relating to the conflict, and a conflict resolution input for retrieving information from a user indicative of a conflict resolution. This provides an efficient way to resolve the conflict according to the wishes of the user.

The conflict resolution means may comprise automatic conflict resolution means for applying a predetermined set of conflict resolution rules to the conflicting policy rules to resolve the conflict, the conflict resolution input being applied if the set of conflict resolution rules do not suffice to resolve the conflict. This reduces the number of times the user is asked to correct the access control policy.

The conflict resolution input may comprise means for retrieving information from the user indicating that one conflicting policy rule has priority over another conflicting policy rule. This allows a user to specify which of the conflicting rules ‘wins’ in case the conflict would arise in practice, during the enforcement of the policy.

The conflict detecting means may comprise means for detecting an inconsistency in the priorities of policy rules indicated by the user. The priorities introduced by correcting one conflict may introduce another conflict, namely an inconsistency in the priorities of the policy rules. The detection hereof allows to resolve this conflict as well. The user may be asked to resolve this new conflict, for example by further refining the priorities.

The user interface may be arranged for representing the access control policy in form of a decision table. A decision table is a relatively intuitive way to specify the access control policy. The translation may comprise a translation of the decision table into the access control policy language. The conflict detection means and conflict resolution means may be arranged for operating on the decision table, before translation into the access control policy language.

The conflict detection means may be arranged for being activated after adding or changing a policy rule by the user. This way, quick feedback can be provided to the user.

The conflict detection means may be arranged for verifying whether two rules apply to the same subject, based on subject attributes referenced in at least one of the conflicting rules. Subject attributes may include, for example, a role or a group. The policy rule may then apply to a subject which has a specific role or which is a member of a specific group. Conflicting policies have at least one subject in common, and one of the conflicting rules may deny access, while another conflicting rule may allow access by the subject.

The machine readable security policy language may comprise the extendable access control markup language XACML. XACML is a suitable access control policy language.

The access control policy enforcing unit may comprise an input for receiving the translated access control policy; and policy enforcement means for enforcing the received access control policy. This allows an effective enforcement of the policy.

The output may be arranged for transmitting the translated access control policy via a wide area network to the access control policy enforcing unit, the access control policy enforcing unit being remote from the user interface, translation means, and output. This is a configuration suitable for a remote client which sets up a policy free of conflicts and translated into an access control policy language and transmits the policy to the access control policy enforcing unit.

A method of specifying an access control policy to medical patient data may comprise

enabling a user to specify a plurality of policy rules comprising a subject attribute, an object, an action, and an authorization, the policy rules defining an access control policy;

translating the access control policy into a machine readable data access control policy language to obtain a translated data access control policy; and

providing the translated data access control policy to an access control policy enforcing unit.

A computer program product may comprise computer executable instructions for causing a processor system to perform the steps of the method set forth.

### BRIEF DESCRIPTION OF THE DRAWINGS

These and other aspects of the invention will be further elucidated and described with reference to the drawing, in which

FIG. 1 is a block diagram illustrating aspects of a system for specifying an access control policy and an access control policy enforcing unit;

FIG. 2 is a block diagram illustrating steps of a method of specifying an access control policy;

FIG. 3 is a block diagram illustrating further aspects of a system for specifying an access control policy; and

FIG. 4 is a block diagram illustrating steps of a method of conflict detection.

### DETAILED DESCRIPTION OF EMBODIMENTS

In modern healthcare IT systems, patient consent may be taken into account by security mechanisms that govern access to patient' health data. XACML is an XML language increasingly used for specifying access control policies. However, specifying correct XACML policies is challenging due to its complexity. A method for automatic translation of a high level privacy policy for patient consent to a machine readable policy language such as XACML is described herein. However, XACML is only a non-limiting example. This method may include detection of potential conflicts and their resolution.

In consumer wellness and healthcare domain advances in information and communication technologies have enabled remote healthcare services (telehealth) including telemedicine and remote patient monitoring. A number of services already deploy telehealth infrastructures where the measurement devices are connected via home hubs to remote backend servers. Healthcare providers use this architecture to remotely access the measurement data and help the patients. Examples are disease management services or emergency response services.

Interoperability of measurement devices, home hubs and backend services is important for enabling successful operation of the services. Protocols between measurement devices, home hub (application hosting) devices, online healthcare/wellness services and health record systems (PHRs/EHRs) may be standardized. Next to data format and exchange issues, security and safety issues may be addressed.

In such an architecture including home hubs and backend services, measurement devices and the application hosting device should be able to connect to different services in a more or less ad hoc manner. Sensitive patient data is collected throughout the patient's life, and measurements performed by disease management, health and fitness, and aging independently services may be included in the patient's health records. On its journey though a number of open and interoperable systems, sensitive health data should be used only for the purpose(s) that the patient has consented to, i.e. according to his privacy policy.

Written consent used in practice in the regulated healthcare domain is static and is not customized for each individual patient and therefore does not sufficiently capture consent and the patient privacy policy in the consumer wellness and healthcare scenarios. For patient consent to be taken into consideration in the access control mechanisms, access control policies are preferably expressed in electronic form. Furthermore, the consent needs to be expressed in a form that is recognized by the access control mechanisms (in order to ease its enforcement).

A way to do that is to specify a policy in a machine readable format. Specific security policy languages exist that represent policies in machine readable formats. XACML is one such policy language developed by OASIS that has found an important application in the healthcare domain (HL-7, HITSP). However, specifying correct XACML policies is challenging, since access control policies are complex due to the amount and complexity of the information they manage. Therefore, it would be advantageous to capture a high-level patient consent/privacy policy and translate it into a machine readable XACML policy that can be used by access control and DRM (digital rights management) mechanisms. Preferably, measures are taken to check that the translated access control policy is as intended and does not have conflicts.

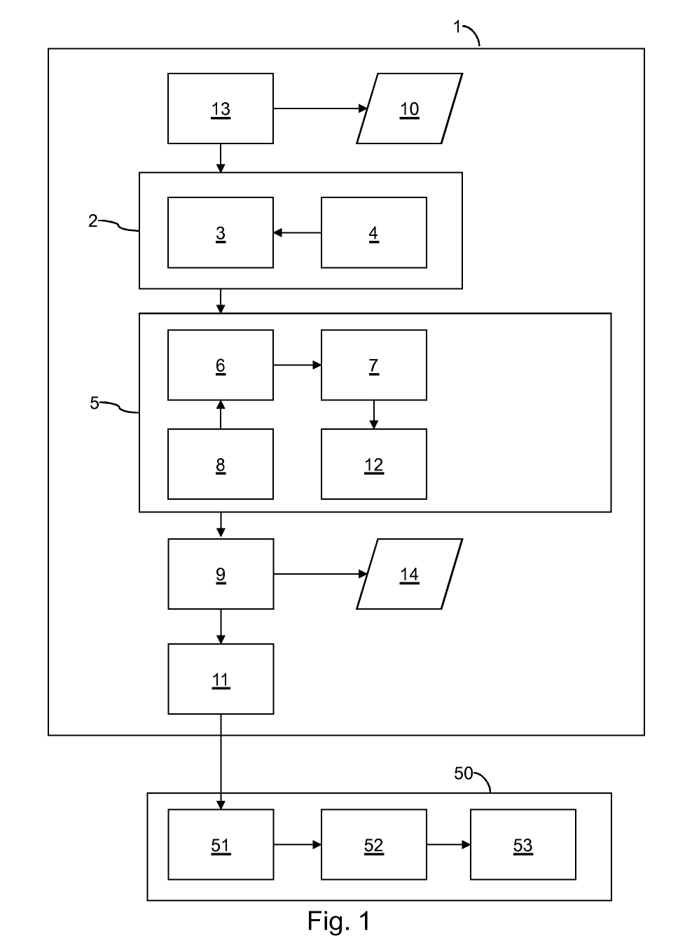

FIG. 1 illustrates a system 1 for specifying an access control policy 10. The system 1 can be implemented, for example, in a home device such as a mobile phone or a personal computer or laptop. The system 1 can also be implemented on a terminal in a hospital, for example, wherein the patient or a nurse controls operation of the system 1. The system 1 may also be implemented using other hardware, for example hardware which is part of patient monitoring equipment. The system 1 includes a user interface 13. The user interface 13 may be a graphical user interface or a textual interface, for example. The user interface 13 provides user interface elements, for example buttons and/or text entry fields, which a user can use to specify a plurality of policy rules. Such policy rules may define permissions for accessing medical or personal data relating to a patient. A policy rule may comprise for example a subject attribute, an object, an action, and an authorization. Herein, the subject attribute defines to which subjects the policy rule applies. More particularly, the subject attributes define attributes that the subject needs to be able to access the data. That could be name, role, location, diplomas, certificates, etc. A subject can be the person or entity in respect of which the policy rule should be enforced. Together, a set of policy rules entered via the user interface may define a high-level access control policy 10. Such high-level access control policy may be human readable, but it may not be in a format which is easily used by a machine. Such an access control policy may refer to a collection of policy rules which define the access restrictions of a certain piece of data, for example the data relating to a particular patient. Thus, the access control policy 10 is established at least in part based on user input via the user interface. The access control policy 10 may also be defined or constrained in part by the policy of an institute which has responsibilities in respect of the data, for example an institute which stores the data or which provides care to the patient based on the data may restrict the possible policy rules that a patient can incorporate in his or her personal access control policy 10.

The system 1 may comprise a translation means 9 for translating the access control policy 10 into a machine readable data access control policy language to obtain a translated data access control policy 14. After the user has specified the access control policy 10 via the user interface 13, the user for example presses a button indicating that the access control policy 10 is complete and finalized. After that, the translation means 9 translates the policy rules in the access control policy 10 into a language description which can be processed by standard policy enforcing means which are configured to process the translated access control policy 14 defined in the access control policy language. Alternatively, the translation means 9 may be arranged for updating the translation 14 during the process of defining the access control policy via the user interface 13. For example, each time a user adds, modifies, or deletes a policy rule, the translation means 9 adds, modifies, or deletes, respectively, text of the translated access control policy 14.

The system 1 may further comprise an output 11 for providing the translated data access control policy 14 to an access control policy enforcing unit 50. For example, the output is arranged for transmitting data via a network to which the system 1 may be connected. Such network may be a wide area network, for example the Internet, or a local area network. In another configuration, the system 1 may be partly or completely integrated with an access control policy enforcing unit. In such a case, the output may be arranged to provide the translated access control policy 14 to the access control policy enforcing unit 50 by an internal system message, or for example by saving it in a particular location.

The system 1 may comprise a conflict detection means 2. The conflict detection means 2 is arranged for detecting if conflicting policy rules exist in the access control policy. The conflict detection means 2 is arranged for detecting at least two conflicting policy rules indicative of denial and allowance, respectively, of a possible access request. These policy rules are conflicting, because normally all access requests should resolve to either permit or deny. The conflict detection means 2 may be arranged for detecting conflicting policy rules by looking for rules which are indicative of denial and allowance, respectively, of a particular type of access to a particular object by a particular subject. Such type of access, object, and subject may be defined implicitly by the policy rule. For example, the subject may be defined in the policy rule in terms of subject attributes, for example a role several subjects may have or a group of subjects. If subject attributes of two rules are different, it is still possible that one or more the same subjects are covered by the different policy rules, which may give rise to conflicting permissions.

The input to the conflict detection means 2 (provided by the user interface 13) may be in form of an attribute table which may show possible overlaps among attributes (such as subject attributes). In detecting such overlaps, additional information may be used which may be obtained from an external attribute authority or identity management system, for example. Such external attribute information may include information on subject's roles, for example.

A conflict resolution means 5 may be provided for resolving the conflict in the at least two conflicting policy rules. This way, a corrected access control policy is obtained. In the drawing, no distinction is made between the access control policy and the corrected access control policy. Both are indicated at 10. The conflict resolution means may comprise a conflict indication means 6 for indicating to a user information relating to the conflict. For example, the conflicting policy rules may be highlighted. Moreover, the subject(s) or case(s) in which the rules are conflicting may be indicated to the user to make clear what the exact conflict is. A conflict resolution input 7 may be provided for retrieving information from a user indicative of a conflict resolution. The user may for example decide to add an additional policy rule relating to the conflicting case(s) and adapt the existing policy rules such that they no longer apply to the conflicting case(s).

The conflict resolution means 5 may comprise automatic conflict resolution means 8. This means 8 can handle at least some of the conflicting rules automatically and either propose the automatically generated resolution to the user or fully automatically implement the conflict resolution, without involving the user. The automatic conflict resolution means 8 is arranged for applying a predetermined set of conflict resolution rules to the conflicting policy rules to resolve the conflict. If the predetermined set of conflict resolution rules does not resolve the conflict, the conflict resolution indication means 6 and/or conflict resolution input 7 may be applied to allow the user to manually correct the conflict.

The conflict resolution input 7 comprising means 12 for retrieving information from the user indicating that one conflicting policy rule has priority over another conflicting policy rule. This means that during the enforcement, if the conflicting situation occurs, the policy rule which has priority is applied in favor of the other policy rule.

The conflict detecting means 2 may comprise means 4 for detecting an inconsistency in the priorities of policy rules indicated by the user. If priorities have to be given more than once, it is possible that inconsistencies in the priorities are introduced. Such inconsistencies are preferably resolved because they lead to new situations in which the correct authorization cannot be established during the policy enforcement phase.

The user interface may be arranged for representing the access control policy 10 in form of a decision table. Such a decision table may contain a policy rule in each row, and each column may relate to a particular attribute of a policy rule. For example, a column may contain subject attributes of each policy rule. Such a column controls which subjects are granted or denied authorization by a policy rule. Another column may contain the object. The object defines the data to which access is granted or denied. Another column may contain the effect, or whether access is permitted or denied. More columns may be defined in the decision table; an example is given elsewhere in this description.

The conflict detection means 2 may be arranged for being activated after adding or changing a policy rule by the user. This way, detection and/or correction of conflicts is made interactive: conflicting rules may be identified immediately after they have been created.

The conflict detection means 2 may be arranged for verifying whether two rules apply to the same subject, based on subject attributes referenced in at least one of the conflicting rules. The subject attributes control to which subjects the policy rule applies. In principle, rules can only be conflicting if there is at least one subject to which the conflicting policy rules both relate.

The machine readable security policy language may comprise the extendable access control markup language XACML. The translation means 9 may be arranged to translate the access control policy 10 into a XACML policy. The translation means 9 may be arranged to translate the access control policy 10 from a decision table into a XACML policy.

Further, an access control policy enforcing unit 50 may be provided. This may be connected with the system 1 by communication means indicated above in conjunction with the output 11. The access control policy enforcing unit 50 may comprise an access control policy input 51 for receiving the translated access control policy from the system 1 via the output 11. Moreover, as an example, the access control policy enforcing unit 50 may comprise a policy enforcement means 52 for enforcing the received access control policy. This policy enforcement means 52 may process the translated access control policy 14 and apply the rules represented therein to permit and/or deny particular access requests. The policy enforcing unit 50 may further comprise access request processing means 53 for receiving an access request, verifying the authorization via the policy enforcement means 52, and, depending on the output of the policy enforcement means 52, perform the access as requested or refuse the access request. However, this is only an example of an architecture. It would also be possible to reference, for example, a XACML reference access control system architecture.

The output 11 of the system 1 may be arranged for transmitting the translated access control policy via a wide area network to the access control policy enforcing unit, the access control policy enforcing unit 50 being remote from the system 1 including, for example, the user interface 13, translation means 9, and output 11. This way, the access control policy is prepared by the system 1 and sent to the access control policy enforcing unit 50 where it can be readily applied.

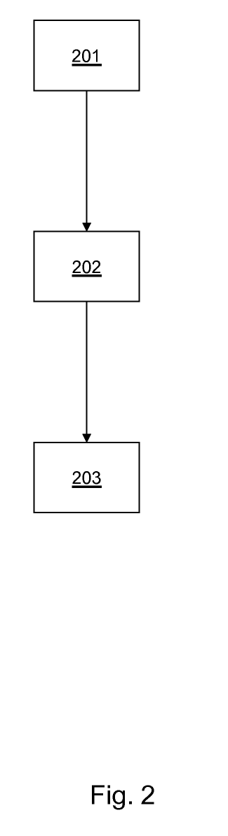

FIG. 2 illustrates a method of specifying an access control policy. The method comprises enabling 201 a user to specify a plurality of policy rules comprising a subject attribute, an object, an action, and an authorization, the policy rules defining an access control policy. The method further comprises translating 202 the access control policy into a machine readable data access control policy language to obtain a translated data access control policy. The method further comprises providing 203 the translated data access control policy to an access control policy enforcing unit. The method may be implemented as a computer program product comprising computer executable instructions for causing a processor system to perform the steps of the method.

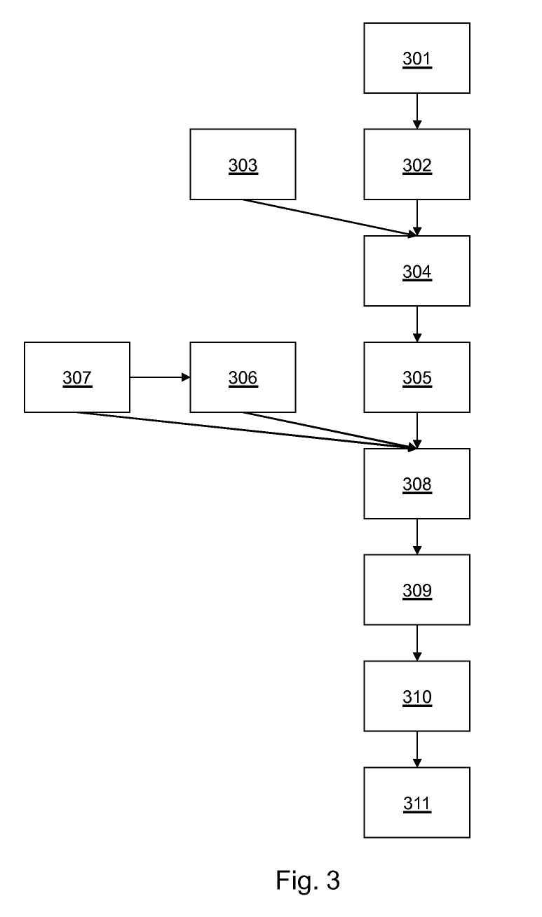

FIG. 3 illustrates a method for translation of a high level privacy policy into a machine readable policy such as a XACML policy including detection of potential conflicts and their resolution which method may comprise the following steps:

specification 301 of a privacy policy via a graphical user interface in a decision table 302;

detection 304 of potential conflicts using the decision table 302 and an attribute table 303 (created based on external information such as hospital or national EHR infrastructure);

interactive resolution 308 of detected conflicts 305 using a conflict resolution policy 306 and/or user input 307, resulting in a prioritized list 309 of policy rules of the decision table; and

translation 310 of the prioritized list 309 of policy rules from the decision table into a XACML policy 311.

Specification of a privacy policy via a graphical user interface in a decision table can be implemented as follows. Patient consent expresses authorizations that specify whether an entity is granted or denied access to part or all of a patient's medical information, to perform some action on the information and the conditions in which this should be done. Therefore, the patient has to specify these elements of consent as authorizations that will be enforced during access control. The following elements of consent may be identified:

Grantor: This is the person who grants the consent (the patient or a legal custodian of the patient).

Grantee: This is the individual, role or group to which consent is granted.

Patient: This is the patient in question whose data will be accessed by the grantee.

Action: This is the action or the operation that the grantee is allowed or not allowed to perform on the data. Examples of such operations include read, write, collect, access, use, disclose, amend, or delete.

Data: An expression that represents all or part of the patient's medical information.

Effect: This may be ‘permit’ or ‘deny’.

Purpose: This specifies the purpose for which the grantee can access the data. These may include for example ‘treatment’, ‘payment’, ‘operations’, ‘research’, ‘public health’, ‘planning’, ‘quality measures’, ‘health status evaluation by third parties’ and ‘marketing’. Other purposes may be defined according to needs.

Context: This specifies the context within which the policy rule applies. Two exemplary contexts have been identified; the grantee can access the patient's data in ‘normal’ or ‘emergency’ situations. Other contexts may be defined according to needs.

Validity period: This is the period within which the policy rule is valid.

Consent may be specified using a graphical user interface that helps a patient to fill in a decision table. In the decision table below an example of consent is specified. The first two rows of the decision table contain default authorizations, while the rest of the rows contain specific authorizations which are exceptions to the default authorizations. The default authorization may be a general permission to allow access, unless an exception applies. In the example of Table 1, the default authorizations specify that in general access is not allowed (effect ‘-’ in the two top rows).

TABLE 1
Decision table

| Auth | | | | | | | | |
|---|---|---|---|---|---|---|---|---|
| No. | grantee | act. | data | Effect | Purpose | Context | V | T |
| 1 | | read | /patient ID/* | − | | | | A |
| 2 | | write | /patient ID/* | − | | | | A |
| 3 | Personal | read | /patient ID/* | + | all | all | | A |
| | Doctor | | | | | | | |
| 4 | Personal | write | /patient ID/* | + | all | all | | A |
| | Doctor | | | | | | | |
| 5 | Doctor | read | /patient ID/* | + | treatment | all | 1 | A |
| 6 | Doctor | write | /patient ID/* | + | treatment | all | 1 | A |
| 7 | Dr. John | read | /patient ID/* | + | treatment | emergency | | A |
| | Mathews ID | | | | | | | |
| 8 | Dr. John | write | /patient ID/* | + | treatment | emergency | | A |
| | Mathews ID | | | | | | | |
| 9 | Husband ID | read | /patient ID/* | + | all | all | | D |
| 10 | Mother ID | read | /patient ID/* | + | all | all | | A |
| 11 | Mother ID | read | /patient ID/ | − | all | all | | A |
| | | | Gynecological | | | | | |
| | | | Information/* | | | | | |
| 12 | Mother ID | read | /patient ID/ | − | all | all | | A |
| | | | Blood pressure | | | | | |
| | | | [age <= 3 | | | | | |
| | | | months] | | | | | |

(In the top row, act. stands for action, V stands for validity period in years, and T stands for Authorization type. In the right most column, A stands for Access, D stands for Delegate. ‘Effect’ means authorization, ‘+’ means permit, ‘−’ means deny)

Conflicts in policies may arise when the objectives of two or more authorizations cannot be simultaneously met, due to positive and negative authorizations applying to the same objects. In general, the goals of conflict detection are to identify an actual conflict that has occurred and/or to predict that a potential conflict may occur in the future. Next to that the actual or potential conflicts may be communicated to a resolution process. The conflicts may result from the overlap of the subject, resource, action and condition elements in authorization policies which have opposite authorizations.

For conflict detection an attribute table may be used. An attribute table identifies for grantees specified in the decision table of a patient's consent policy, the other possible roles or groups that the grantee can have amongst those specified in the patient's policy (e.g. a doctor can also have a role of a personal doctor, a specific healthcare provider can have several roles, etc.). This table may be provided by an identity management provider of a hospital or a national EHR infrastructure.

A role can be seen as an attribute of a user. For example, two rules may read:

rule1: attribute.subjectname=“John”, object=O1, action=view, deny;

rule2: attribute.role=“emergency.doctor”, object=O1, action=“view”, permit.

These two rules might be conflicting if John takes the role of an emergency doctor. Combinations of different attributes can be used. Other rules may use attributes based on location or department, for example. Such rules may also give rise to conflicts, such as in the following example wherein the rules refer to overlapping locations:

rule1: attribute.location=“Hospital1”, object=O1, action=view, deny;

rule2: attribute.location=“Hospital1.emergency.room”, object=O1, action=“view”, permit.

Access policy rules may relate to some data. The data may be indicated by means of an XPath expression. XPath is a format known in the art by itself However, this is only an example used in this description. Other ways of specifying the data can be used instead.

Conflict detection may involve the following.

A (potential) subject overlap is detected: for two authorizations being compared, there may be a subject overlap if the grantee elements have the same value, or if the grantee element of one of the authorizations has in its ‘possible roles/groups’ column in the attribute table, the grantee element of the other authorization rule.

Data overlaps are now checked in the XPath expressions that represent the patient's medical information in the authorizations. In the literature, a number of algorithms that detect containment or intersection between XPath have been presented. For the detection of data overlap, the preferred intersection algorithm is run on the data elements of the authorization rules. If the XPath expressions intersect then a data overlap exists and conflict is possible. Otherwise, if the XPath expressions have no overlap, then the authorizations are not in conflict with each other, since they refer to different data items.

Action overlap is checked: If the actions of two authorizations are different, then these two authorizations are not in conflict. This is because these two rules refer to different operations, and cannot therefore be both applicable to the same access request. However, if the actions are the same, potential for conflict exists. The actions are simply compared, and if they are equal action overlap exists.

Condition overlap is checked: The elements of the authorizations that are compared during the condition overlap check are the purpose (condition 1) and context (condition 2) elements. The condition pairs of two authorization rules can have one of the following relationships:

condition 1 and condition 2 intersect

condition 1 and condition 2 are disjoint

condition 1 and condition 2 are equal

Two condition pairs are considered to intersect when they have the same value for one of the purpose or context elements, but different values for the other one; or when one of the authorizations has the value ‘all’ in the purpose or context elements, since the value ‘all’ will include whichever value specified in the other authorization's purpose or context element. On the other hand, two condition pairs are disjoint when all the purpose and context values are different and none of the purpose or context elements of both authorizations have the value ‘all’. Finally, two condition pairs are considered to be equal when both purpose and context values of both authorizations are the same; when one authorization has the value ‘all’ for the purpose element while the context elements of both authorizations contain the same value, or vice versa; when one authorization has the value ‘all’ for both purpose and context elements; or when one authorization has the value ‘all’ for the purpose element while the other authorization has the value ‘all’ for the context element, or vice versa.

When the condition pairs are equal, there is the possibility of conflict depending on the status of the other elements in the authorization rule. This is because the conditions may apply to the same access requests. When two condition pairs intersect or are disjoint, there is normally no possibility of conflict. This is because regardless of the fact that the condition pairs may have some elements in common, the condition pairs in their entirety are different. The consequence of this is that authorization rules whose conditions intersect or are disjoint, will normally not applicable to the same access request. Since their conditions are different, they are not in conflict with each other.

The sign, action, subject, data and condition overlap checks are part of the conflict detection algorithm, which is summarized in the conflict detection tables that are shown below.

TABLE 2
Action, sign and conditions overlap table

| | | Disjoint | Intersecting | Equal |
|---|---|---|---|---|
| Effect | Action | Conditions | Conditions | Conditions |
| same | same | — | — | — |
| different | same | — | — | Conflict Possible |
| | | | | Check table 3 |
| same | different | — | — | — |
| different | different | — | — | — |

(— means that a conflict is not possible for that combination of Effect, Action, and Conditions)

TABLE 3
Subject overlap table
Subject Overlap

| | |
|---|---|
| No overlap | Overlap |
| No Conflict | Possible |
| | Check table 4 |

TABLE 4
Data overlap table
Data Overlap

| | |
|---|---|
| No overlap | Overlap |
| No Conflict | Conflict |

The authorizations may be compared and the results may be stored in a conflict matrix (a cell is marked if there is a conflict between related rules).

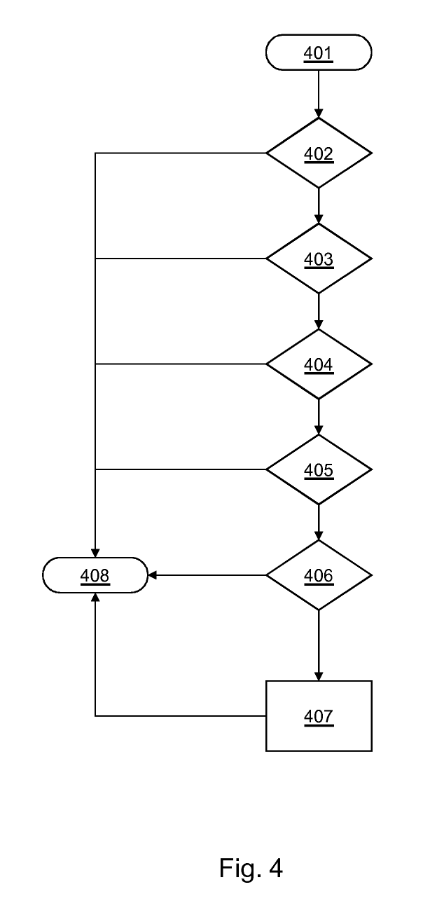

FIG. 4 illustrates a process of verifying whether two policy rules are in conflict. The process is started at 401. When two authorizations are being compared for conflict, table 2 may be consulted first. The signs of the two authorizations are compared at step 402. If they are the same then the conflict detection algorithm returns a ‘no conflict’ response and the process ends at 408. Otherwise, the actions of the two authorizations are then compared in step 403. If they are different then conflict detection algorithm sends a ‘no conflict’ response and the process ends at 408, else the conditions of the two rules are compared at step 404. If the conditions of the two authorization rules are equal, then conflict is possible, depending on whether or not the grantee and data elements overlap which is checked in steps 405 and 406, respectively. When the conditions intersect or are disjoint, then the conflict detection algorithm returns a ‘no conflict’ response and the process ends at 408. The subject overlap table may be consulted before the data overlap table. If there are no subject overlaps then conflict detection returns a ‘no conflict’ response and the process ends at 408, else the data overlap table may be checked in step 406. If there is no overlap in, for example, the XPath expressions that are the data elements of the two authorization rules, then the conflict detection algorithm returns a ‘no conflict’ response and the process ends at 408. If an overlap is detected in the XPath expressions then the conflict detection algorithm returns a ‘conflict’ response in step 407.

Conflict resolution may involve the following.

The conflict detection matrix may be checked for existence of conflict. If no conflict is found then conflict resolution may be skipped. On the other hand, if conflict is found the two conflicting policy rules may be used as input to the conflict resolution algorithm.

Conflict resolution is preferably done in an automatic way using locality (specificity) conflict resolution strategy. However, this is not a limitation. For the specificity of the authorizations it may be checked if:

data of one authorization is a subset of the other (XPath containment)

one action is contained in another (actions have an action hierarchy)

grantees are roles/groups that have a role/group hierarchy

condition of one authorization is more specific than the other

If this strategy does not resolve a conflict, or if a patient prefers not to use this strategy, the conflict may be resolved by the patient himself by assigning priorities to rules manually. This process is supported by allowing the patient to decide which of two conflicting rules should have priority. However, when more conflicts are resolved in this way, it may occur that at some point, the rules are in conflict. In an example with three rules in conflict: first rules A and B are in conflict (user resolved that B has priority); then rules B and C are in conflict (user decided C has priority); then rules A and C are in conflict (user decided A has priority). In this example, the conflicts between these three rules have not been adequately resolved because no single one of the three can be established to have highest priority. This can be found by analyzing the priorities as a directed graph. Vertices in such a graph represent policy rules. A directed edge in such a graph indicates that one policy rule has higher priority than another policy rule. The system preferably helps the patient not to introduce cycles in the graph. To prevent the introduction of cycles, a directed acyclic graph may be incrementally created and checked during conflict resolution. The graph may be searched for the existence of both conflicting rules which have just been resolved. If one or both of these rules do not exist as vertices in the graph, or are in disconnected components of the graph, then there is no conflict in the priorities. In this case, conflict resolution can proceed. Otherwise, the grantor is informed of the existing priorities of the authorizations. The system can suggest to the patient priorities for rules (for example, based on a default conflict resolution strategy of the original order of rules in which the patient specified them).

Finally priority values may be assigned to the rules in the following manner for the non-conflicting rules:

The default authorization rules are assigned priorities first. They are assigned the low value priorities in a random fashion.

The specific authorizations are then assigned priorities. The priorities assigned to specific authorizations are higher than the priorities assigned to default authorizations, and the priorities are assigned randomly.

Those rules that had conflicts are then assigned higher priority values by carrying out a topological sort on the two directed acyclic graphs for the default and specific authorizations. The graph that represents the default authorizations may be traversed first, while the graph that represents the specific authorizations may be traversed second. Priority values may be assigned in ascending order of the lists generated by the topological sorts. The default authorizations are given lower priorities than the specific authorizations. During enforcement, higher priority rules are processed first. The highest priority applicable rule is enforced.

Translation to an access policy language such as XACML may involve the following.

The translation algorithm may take as input the prioritized decision table from the conflict resolution algorithm. Each element of an authorization has already been identified as a subject, action, resource or environment attribute. These elements are then mapped to policy and rule targets. Policy targets are used to identify applicability of a policy to an access request and may therefore contain all the subject, action and resource elements of all authorization rules. This is done by including all grantees of the authorization rules and the patient identity as subject attributes, all actions as action attributes and using the XPath expression that represents all of the patient's medical information as the resource attribute.

The resource attribute of the policy target is the XPath expression that represents all of the patient's medical information and can be extracted from any of the default authorizations. The patient's unique identity is extracted from the decision table, and is included as a subject attribute of the policy's target.

Each authorization is processed to derive its grantee and action elements. These elements are used in the policy's target in the following manner:

The grantee of the authorization rule is included in the subject attribute of the target.

The action of the authorization rule is included as an action attribute of the target.

Rule targets are more specific and refer to a particular grantee, action and optionally some section or even element of the patient's data represented in an XPath expression.

XACML rule targets may be constituted in the following manner:

The resource attribute of the rule will be the authorization's data element. However, if the data element is the XPath expression that represents all of the patient's medical information, the resource attribute may be omitted from the rule's target because it is similar to the policy's resource attribute.

Since the grantees mentioned in the policy are included as subject attributes of the target of the policy, the rule target has to be specific on which grantee the rule applies to. Therefore, the subject attribute of the rule target is the grantee of the authorization.

Similar to the subject attributes in the policy's target, the action attributes of the target of the policy are made up of the actions that are mentioned in the policy. The rule target has therefore to specify which action in particular is applicable to the rule.

The purpose and context elements can be represented with an entry ‘all’. The authorizations with the value ‘all’ in either the context and/or purpose elements may be represented by as many rules as there are combinations for the purpose and/or context elements. These rules may have the same priority value, which is the one given to the authorization from which they are derived. Since they are all disjoint, and are not in conflict owing to the different values in their purpose and context elements, they can have the same priority value.

An access control mechanism may support prioritized XACML rules. In the XACML standard, a way of representing priority values for the rules of a policy is not specified, therefore XACML rules with priorities are not directly used. To address this problem, the priority values specified in the rules of the policy are translated to the actual ordering of the rules in the policy. The rules are arranged in the XACML policy in descending order of priority. The rule with the highest priority is written at the top of the policy, and the rest of the rules follow in descending order of priority. This enables the use of the first applicable rule combining algorithm defined in XACML. This rule combining algorithm evaluates the rules in the order in which they have been written in the policy. If a rule evaluates to ‘permit’ or ‘deny’ then the evaluation of the policy halts and the decision is returned as the response of the policy. Conversely, if a rule evaluates to ‘not applicable’ then the next rule is evaluated, and if the end of the policy is reached then the algorithm returns a not applicable decision. In this fashion, the rule with the highest priority applies for an access request. This allows the use of the disclosed method without any changes of the XACML standard.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for specifying an access control policy, comprising
a user interface (13) for enabling a user to specify a plurality of policy rules comprising a subject attribute, an object, an action, and an authorization, the policy rules defining an access control policy (10);
a translation means (9) for translating the access control policy into a machine readable data access control policy language to obtain a translated data access control policy (14); and
an output (11) for providing the translated data access control policy to an access control policy enforcing unit (50).

2. The system according to claim 1, further comprising a conflict detection means (2) for detecting at least two conflicting policy rules indicative of denial and allowance, respectively, of a possible access request.

3. The system according to claim 2, wherein the conflict detection means (2) is arranged for detecting conflicting policy rules which are indicative of denial and allowance, respectively, of a particular type of access to a particular object by a particular subject.

4. The system according to claim 2, further comprising a conflict resolution means (5) for resolving the conflict in the at least two conflicting policy rules to obtain a corrected access control policy, the conflict resolution means (5) comprising
a conflict indication means (6) for indicating to a user information relating to the conflict, and
a conflict resolution input (7) for retrieving information from a user indicative of a conflict resolution.

5. The system according to claim 4, the conflict resolution means (5) further comprising automatic conflict resolution means (8) for applying a predetermined set of conflict resolution rules to the conflicting policy rules to resolve the conflict, the conflict resolution input (7) being applied if the set of conflict resolution rules do not suffice to resolve the conflict.

6. The system according to claim 4, the conflict resolution input (7) comprising means (12) for retrieving information from the user indicating that one conflicting policy rule has priority over another conflicting policy rule.

7. The system according to claim 6, the conflict detecting means (2) comprising means (4) for detecting an inconsistency in the priorities of policy rules indicated by the user.

8. The system according to claim 1, the user interface (13) being arranged for representing the access control policy (10) in form of a decision table.

9. The system according to claim 2, the conflict detection means (2) being activated after adding or changing a policy rule by the user.

10. The system according to claim 2, the conflict detection means (2) being arranged for verifying whether two rules apply to the same subject, based on subject attributes referenced in at least one of the conflicting rules.

11. The system according to claim 1, the machine readable security policy language comprising the extendable access control markup language XACML.

12. The system according to claim 1, further comprising the access control policy enforcing unit (50), the access control policy enforcing unit (50) comprising
an access control policy input (51) for receiving the translated access control policy; and
policy enforcement means (52) for enforcing the received access control policy.

13. The system according to claim 12, the output (11) being arranged for transmitting the translated access control policy (14) via a wide area network to the access control policy enforcing unit (50), the access control policy enforcing unit (50) being remote from the user interface (13), translation means (9), and output (11).

14. A method of specifying an access control policy, comprising
enabling (201) a user to specify a plurality of policy rules comprising a subject attribute, an object, an action, and an authorization, the policy rules defining an access control policy;
translating (202) the access control policy into a machine readable data access control policy language to obtain a translated data access control policy; and
providing (203) the translated data access control policy to an access control policy enforcing unit

15. A computer program product comprising computer executable instructions for causing a processor system to perform the steps of the method according to claim 14.
